(19) United States
(12) Patent Application Publication
(10) Pub. No.: US 2020/0159866 A1
(43) Pub. Date: May 21, 2020

(54) Perceived Web Page Loading Time

(71) Applicant: International Business Machines Corporation, Armonk, NY (US)

(72) Inventors: Wen Tao Dong, Beijing (CN); Hui Chuan Zhao, Beijing (CN); Su Liu, Austin, TX (US); Wei Wu, Beijing (CN)

(21) Appl. No.: 16/195,451

(22) Filed: Nov. 19, 2018

(51) Int. Cl. G06F 17/30; G06F 17/22

(52) U.S. Cl. CPC G06F 17/30902; G06F 17/2264; G06F 17/3089

(57) ABSTRACT

A method of loading objects in web pages may include applying weights to the viewed zones according to at least one factor, determining a sampled loading time based on an elapsed time of loading of the viewed zones and a percentage of loading of the viewed zones, calculating a perceived loading time based on the sampled loading time and the weights of the viewed zones, and adjusting a subsequent loading of the viewed zones of the web page based on the perceived loading time.

### BACKGROUND

The Internet, a global system of interconnected computer networks that use the Internet protocol suite (TCP/IP) to link devices worldwide, is a network of networks that include private, public, academic, business, and government networks of local to global scope, linked by a broad array of electronic, wireless, and optical networking technologies. The Internet carries a vast range of information resources and services, such as inter-linked hypertext documents and applications of the World Wide Web (WWW), electronic mail, telephony, and file sharing.

### SUMMARY

According to an embodiment of the present invention, a method of loading objects in web pages may include applying weights to the viewed zones according to at least one factor, determining a sampled loading time based on an elapsed time of loading of the viewed zones and a percentage of loading of the viewed zones, calculating a perceived loading time based on the sampled loading time and the weights of the viewed zones, and adjusting a subsequent loading of the viewed zones of the web page based on the perceived loading time.

Further, according to an embodiment of the present invention a computer program product for measuring a perceived web page loading time, the computer program product including a computer readable storage medium comprising computer usable program code embodied therewith, the computer usable program code to, when executed by a processor, may apply weights to viewed zones of a web page according to at least one factor, determine a sampled loading time based on an elapsed time of loading of the viewed zones and a percentage of loading of the viewed zones, and calculate a perceived loading time of the web page based on the sampled loading time the weights of the viewed zones.

Further, according to an embodiment of the present invention, a system for measuring a perceived web page loading time may include a computing device communicatively coupled to a server device through a network. The computing device may include a processor, and a memory device communicatively coupled to the processor. The memory device may include computer usable program code to, when executed by a processor, apply weights to viewed zones of a web page according to at least one factor; determine a sampled loading time based on an elapsed time of loading of the viewed zones and a percentage of loading of the viewed zones; and calculate a perceived loading time of the web page based on the sampled loading time the weights of the viewed zones.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for measuring a perceived web page loading time, according to an example of the principles described herein.

FIG. 2 is a block diagram of a system for measuring a perceived web page loading time, according to an example of the principles described herein.

FIG. 3 is a block diagram of a web page, according to an example of the principles described herein.

FIG. 4 is a flowchart showing a method of loading objects in web pages, according to an example of the principles described herein.

FIG. 5 is a flowchart showing a method of loading objects in web pages, according to an example of the principles described herein.

FIG. 6 is a flowchart showing a method of loading objects in web pages, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The Internet allows individuals and entities the ability to present information to perspective patrons and buyers. Thus, user experience with a particular website, web application, or web-based application may become important since a good user experience may lead to achievement of marketing and sales goals. From the viewpoint of a website developer or website performance engineer, examining network communication time and page speed scores may help in determining the effectiveness of bringing information within a web page to a user. However, it may prove difficult to accurately and precisely determine a user's experience on the website or at a particular web page. Network communication time and web page speed scores do not consider the user's “perceived response time.”

A perceived response time refers to how fast a user observes a web-based application is or how fast a web page or its elements load. The perceived response time is in not a measure of how fast technical statistics indicate the web-based application is or how fast a web page or its elements load. When optimizing a website or web-based application, what a user observes may prove to be what really matters, and not the technical processing that is performed behind the loading of the web page or web application. A user may intend to view a web page, and once a desired or focused portion of the web page is loaded, the user may be allowed to perform other activities on the web page such as, for example select a loaded portion of the web page. Thus, a web page or web application performance goal may be to satisfy most of the users' intention to view, interact with (e.g., surf), or perform other tasks via the web page or the web application as soon as possible and in a way in which the user perceives is faster than previously observed or fast enough.

In some instances, within one page, the loading time may be different from viewed zone to viewed zone. This loading disparity in areas of the web page introduces a challenge in measuring the perceived response time. Further, the end user may be only interested in certain viewed zones of the web page. In some studies, 80-90% of user-perceived latency occurs after the document associated with the web page has been retrieved from the server, but these new timings are to be accurately measured and understood in order to improve the user experience. The financial costs to an individual or entity providing goods or services over a web page or web application is that if an e-commerce website is making, for example, $100,000 per day, a 1 second page delay may potentially cost that individual or entity $2.5 million in lost sales every year.

In all, it may prove difficult to evaluate a user's expected perceive time by analyzing network communication times and web page speed scores. Further, a single web page may contain multiple components, objects, and viewed zones according function, structure, content, and/or user interests. Within one web page, the loading time may be different from viewed zone to viewed zone, which introduces the additional misleading perceived time measurements. Further, the user may be interested in certain zones or sections within a web page.

A good user experience for a web application or web-based application may lead to a win in marketing arid sales. From the viewpoint of a web developer or performance engineer, examining network communication time and page load speed scores may assist in determining a user's potential experience with the web page or web application, but a perceived response time, which refers to how fast a user observes the web-based application or loading of the web page is may be an area of analysis along with or instead of how fast the web page or web application based on technical statistics. When it comes to optimizing a website or web application, it is what the user observes that may matter. The user may intend on viewing a web page, and once his intended portion of a web page is loaded, the user may be allowed to do other activities on the web page. With regard to loading time of a web page or web application, it has been determined that in recent years, an image transmission ratio within a total website on average has increased from 59.2% in 2010 to 64.4% in 2016, and the ratio continues to increase. Indeed, websites with more images attract more of a percentage of visitors as compared to competitive websites. Thus, the examples described herein of calculating perceived time allows for testing the performance of a web page or a web-based application based on a user's intension of viewing an expected portion of the web page. The examples described herein identify the performance with loading a user's intended portions of the web page, and estimates and evaluates user experience for adaptive computing and personalized services.

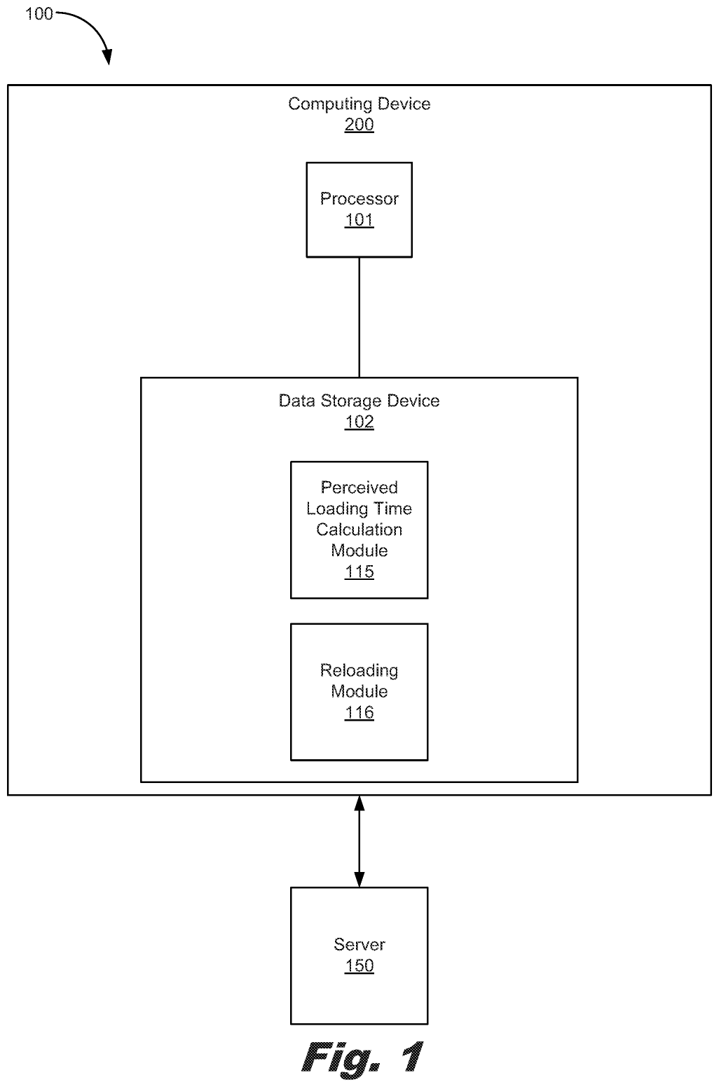

Turning now to the figures, FIG. 1 is a block diagram of a system (100) for measuring a perceived web page loading time, according to an example of the principles described herein. The system (100) provides for the measurement of perceived loading time of a user viewed zone of a web page and include weighted loading time sampling. A single web page may contain multiple components, objects, and zones according function, structure, content, and/or user interests. Within one web page, the loading time may be different from a viewed zone to another viewed zone. This creates a situation where measuring a user-perceived loading time may prove beneficial in improving a user's experience with the web page. A user may be interested in certain zones or sections of a web page, and prioritizing for the loading of those zones of interest may improve the user's experience.

The system (100) may include a computing device communicatively coupled to a server device (150) through a network. The server (150) may be any computing device that provides functionality for other programs or devices (i.e., “clients”) such as the computing device (200). The server (150) may provide various functionalities called “services”, such as sharing data or resources among multiple clients, or performing computation for a client. The server (150) may function as a web server, a database server, a file server, a mail server, a print server, a game server, an application server, and combinations thereof.

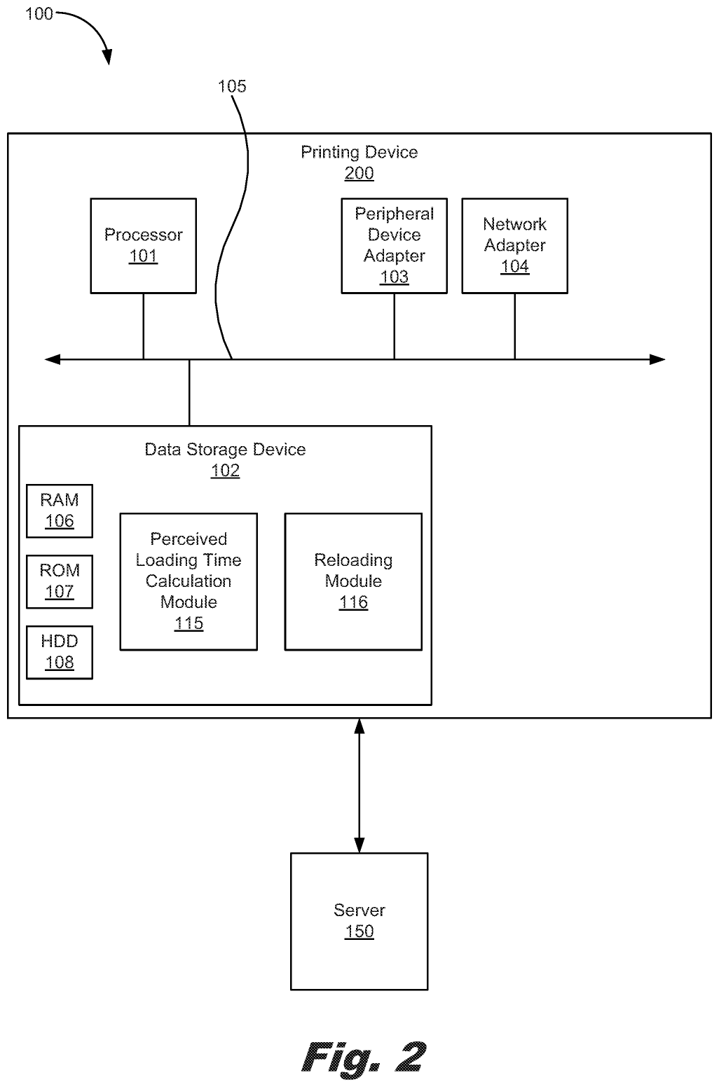

The computing device (200) includes a processor (101), and a data storage device (102) communicatively coupled to the processor (101). The data storage device (102) includes computer usable program code to, when executed by the processor (101) performs tasks as described herein. For example, the computer usable program code may include a perceived loading time calculation module (115) to, when executed by the processor (101), apply weights to viewed zones of a web page according to at least one factor, determine a sampled loading time based on an elapsed time of loading of the viewed zones and a percentage of loading of the viewed zones, and calculate a perceived loading time of the web page based on the sampled loading time the weights of the viewed zones. The reloading module (116) may reload web pages provided by the server (150) based on the perceived loading time in order to optimize a user's experience with the web page. More details regarding the system (100) are provided herein in connection with FIG. 2.

FIG. 2 is a block diagram of a system (100) for measuring a perceived web page loading time, according to an example of the principles described herein. The computing device (200) of the system (100) may be implemented in an electronic device. Examples of electronic devices include servers, desktop computers, laptop computers, personal digital assistants (PDAs), mobile devices, smartphones, gaming systems, and tablets, among other electronic devices.

The computing device (200) may be utilized in any data processing scenario including, stand-alone hardware, mobile applications, through a computing network, or combinations thereof. Further, the computing device (200) may be used in a computing network, a public cloud network, a private cloud network, a hybrid cloud network, other forms of networks, or combinations thereof. In one example, the methods provided by the computing device (200) are provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the computing device (200) are executed by a local administrator.

To achieve its desired functionality, the computing device (200) includes various hardware components. Among these hardware components may be a processor (101), a data storage device (102), a peripheral device adapter (103), and a network adapter (104). These hardware components may be interconnected and communicatively coupled through the use of a number of busses and/or network connections such as via a bus (105).

The processor (101) may include the hardware architecture to retrieve executable code from the data storage device (102) and execute the executable code. The executable code may, when executed by the processor (101), cause the processor (101) to implement at least the functionality of loading objects in web pages including applying weights to the viewed zones according to at least one factor, determining a sampled loading time based on an elapsed time of loading of the viewed zones and a percentage of loading of the viewed zones, calculating a perceived loading time based on the sampled loading time the weights of the viewed zones, and adjusting a subsequent loading of the viewed zones of the web page based on the perceived loading time, according to the methods of the present specification described herein. In the course of executing code, the processor (101) may receive input from and provide output to a number of the remaining hardware units.

The data storage device (102) may store data such as executable program code that is executed by the processor (101) or other processing device. As will be discussed, the data storage device (102) may specifically store computer code representing a number of applications that the processor (101) executes to implement at least the functionality described herein. The data storage device (102) may include various types of memory modules, including volatile and nonvolatile memory. For example, the data storage device (102) of the present example includes Random Access Memory (RAM) (106), Read Only Memory (ROM) (107), and Hard Disk Drive (HDD) memory (108). Many other types of memory may also be utilized, and the present specification contemplates the use of many varying type(s) of memory in the data storage device (102) as may suit a particular application of the principles described herein. In certain examples, different types of memory in the data storage device (102) may be used for different data storage needs. For example, in certain examples the processor (101) may boot from Read Only Memory (ROM) (107), maintain nonvolatile storage in the Hard Disk Drive (HDD) memory (108), and execute program code stored in Random Access Memory (RAM) (106).

The data storage device (102) may include a computer readable medium, a computer readable storage medium, or a non-transitory computer readable medium, among others. For example, the data storage device (102) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The peripheral device adapter (103) and the network adapter (104) in the computing device (200) enable the processor (101) to interface with various other hardware elements, external and internal to the computing device (200). For example, the peripheral device adapters (103) may provide an interface to input/output devices, such as, for example, a display device, a mouse, or a keyboard. The peripheral device adapter (103) may also provide access to other external devices such as the server (150), an external storage device, a number of network devices such as, for example, other servers, switches, and routers, client devices, other types of computing devices, and combinations thereof. The peripheral device adapter (103) may also create an interface between the processor (101) and a display device, a printer, or other media output devices. The network adapter (104) may provide an interface to other computing devices within, for example, a network, such as the server (150), thereby enabling the transmission of data between the computing device (200) and other devices located within the network.

The computing device (200) further includes a number of modules used in the implementation of the functionality described herein. The various modules within the computing device (200) include executable program code that may be executed separately. In this example, the various modules may be stored as separate computer program products. In another example, the various modules within the computing device (200) may be combined within a number of computer program products; each computer program product including a number of the modules.

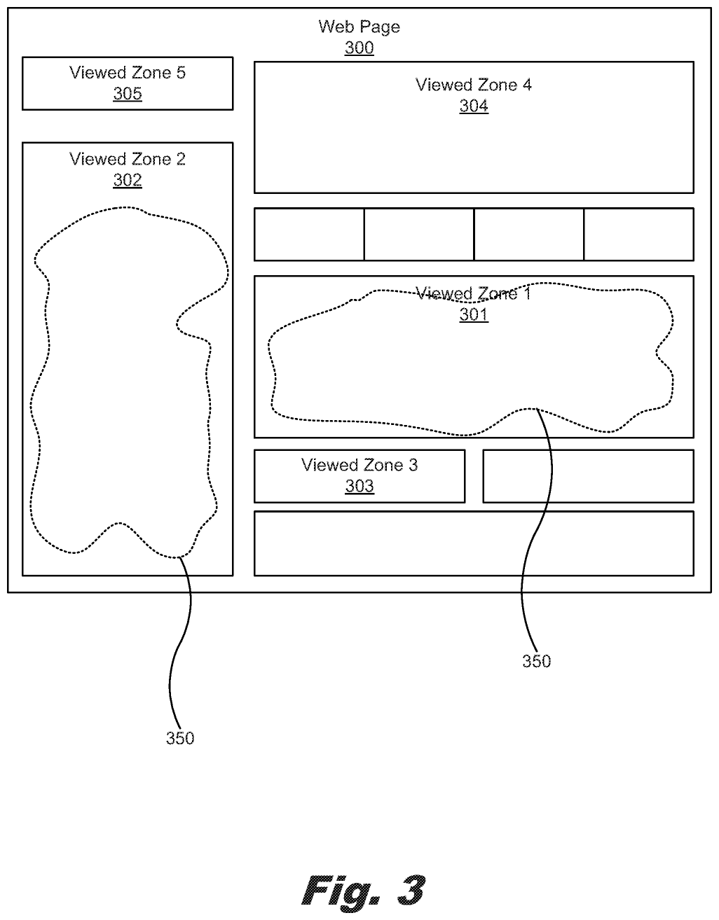

The computing device (200) may include a perceived loading time calculation module (115) to, when executed by the processor (101), calculate a perceived loading time of a web page in order to optimize the loading of the web page. Further, computing device (200) may include a reloading module (116) to, when executed by the processor (101), reload a web page as optimized by the perceived loading time calculation module (115). The manner in which the perceived loading time calculation module (115) and the reloading module (116) function may be understood in connection with a description of FIG. 3. FIG. 3 is a block diagram of a web page (300), according to an example of the principles described herein.

The web page (300) of FIG. 3 may include a number of viewed zones (301, 302, 303, 304, 305). In one example, the perceived loading time calculation module (115) may prompt a user to indicate which viewed zones (301, 302, 303, 304, 305) are of interest to the user. In another example, the perceived loading time calculation module (115) may determine which of the viewed zones (301, 302, 303, 304, 305) the user is interested in based on statistical data such as recognized hot view-zone data collected from the user or other users, past selection of the viewed zones (301, 302, 303, 304, 305) of the web page (300) when browsing the web page (300) and selection of elements within the viewed zones (301, 302, 303, 304, 305), or other autonomous input from the user.

Some portions of web pages (300) may include irregular shapes (350). The irregular shapes (350) within viewed zone 1 (301) and viewed zone 2 (302) may be mapped to rectangle or square shapes as depicted in FIG. 3. This simplifies the processing of the viewed zones (301, 302, 303, 304, 305). The perceived loading time calculation module (115) may be executed on a web browser of the computing device (200) to collect information pertaining to the viewed zones (301, 302, 303, 304, 305), their shapes, and weights applied to the viewed zones (301, 302, 303, 304, 305).

The perceived loading time calculation module (115) may transfer data defining a zone identification, a point array of the viewed zones (301, 302, 303, 304, 305), and weights applied to each of the viewed zones (301, 302, 303, 304, 305) to the data storage device (102) of the computing device (200) in the format <zone id, point array, weight> in order to process the data. With input to the computing device (200) of the viewed zones (301, 302, 303, 304, 305) and weights applied to the viewed zones (301, 302, 303, 304, 305) in the form of the shape, weight, and sampling rate of the viewed zones (301, 302, 303, 304, 305), the multiple application program interfaces (APIs) may be defined by the perceived loading time calculation module (115) to extract and translate data from, for example, other statistical web page analysis outputs, benchmark results received from previous instances of web browsing, user preferences, or other sources of data. The weighted viewed zones (301, 302, 303, 304, 305) may be categorized based on their weight value in instances where the web page (300) includes viewed zones (301, 302, 303, 304, 305) that are similar to one another.

The perceived loading time calculation module (115) may perform a sampling of data from the viewed zones (301, 302, 303, 304, 305) in the form of a time stamp, a zone identification, the number of images within the viewed zones (301, 302, 303, 304, 305), and the size of the viewed zones (301, 302, 303, 304, 305) (<time stamp, zone id, images, size>). In some instances, an initial perceive time stamp may be obtained without reloading the viewed zones (301, 302, 303, 304, 305). However, content within the web page (300) may have changed with updates to the content. For example, the owner of the web site (300) may change or adjust images, text, or other aspects of the web page (300) in order to improve the look or feel of the website, present other or additional items for sale, or present other types of information. In these instances, the web page (300) may be reloaded from the server (150), and its contents may be re-analyzed according to the methods described herein. In situations where the content of the viewed zones (301, 302, 303, 304, 305) shifts each time the web page (300) is loaded, it may be appropriate to perform the sampling performed by the perceived loading time calculation module (115) each time the web page (300) is loaded. In one example, the perceived loading time calculation module (115) may sample the data after the initial data has been captured, and the initial sampled data may be used for reference or comparison during the reloading process in order to make the sampling more accurate.

The perceived loading time calculation module (115) may calculate a number of metrics based on combination of, for example, the zone identification, the perceived loading time, and the loading percentage (<zone id, loading time, loading percentage>), among other metrics. The perceived loading time of each viewed zone (301, 302, 303, 304, 305) may be based on the recognition of a satisfying sample record. A satisfying sample record may exist when a user is satisfied with the manner in which the web page loads and is available for interaction. The loading percentage of a satisfying sample record may be less than 100% because the user may be satisfied when the page is close to 100% loaded due to lazy load, asynchronous technologies, or similar reasons, but is still loads to the point of being available for interaction.

The calculation of loading percentage may be based on image similarity or web traffic comparison within each viewed zone (301, 302, 303, 304, 305). In any case, a satisfying sample record may be determined via a number of approaches. In one example, a satisfying sample record may be determined by developing objective image quality metrics that correlate with perceived quality measurement. For example, the system (100) may implement effective image quality indexing processes in order to rank the captured user interface (UI) image at multiple satisfying levels. For example, the multiple satisfying level may include classifications of “good,” “acceptable,” “moderate,” and “bad,” among other classifications.

In another example, a satisfying sample record may be determined when a web page interaction occurs or is sensed by the system (100). A web page interaction may include, for example, a web page selection or “click,” when a drop-down menu is selected, when a scrolling of the web page is detected, when a menu is selected, or a combination thereof. When the web page interaction is detected, the web page loading percentage may be calculated for associated viewed zones (301, 302, 303, 304, 305) in the current web page since the viewed zone (301, 302, 303, 304, 305) is likely to be ready for interaction and the viewed zone (301, 302, 303, 304, 305) is sufficiently loaded.

In another example, a satisfying sample record may be determined by a threshold or a “rule of thumb.” In sonic examples, for viewed zones (301, 302, 303, 304, 305) that include text only, images only, or mixed with both text and images, the threshold may be 95%. In one example, the loading percentage may be set to 100% for performance optimization purposes.

In the examples described herein, the loading percentage may be presented as a percentage number of displayed viewed zones (301, 302, 303, 304, 305) per total viewed zones (301, 302, 303, 304, 305), or as transferred data size per total data size of the viewed zone (301, 302, 303, 304, 305). Further, determining a sampled loading time based on an elapsed time of loading of the viewed zones and a percentage of loading of the viewed zones may include changing the elapsed time to a loading time to make the processes more accurate. Having described the system (100), the methods provided by the system will now be described in more detail.

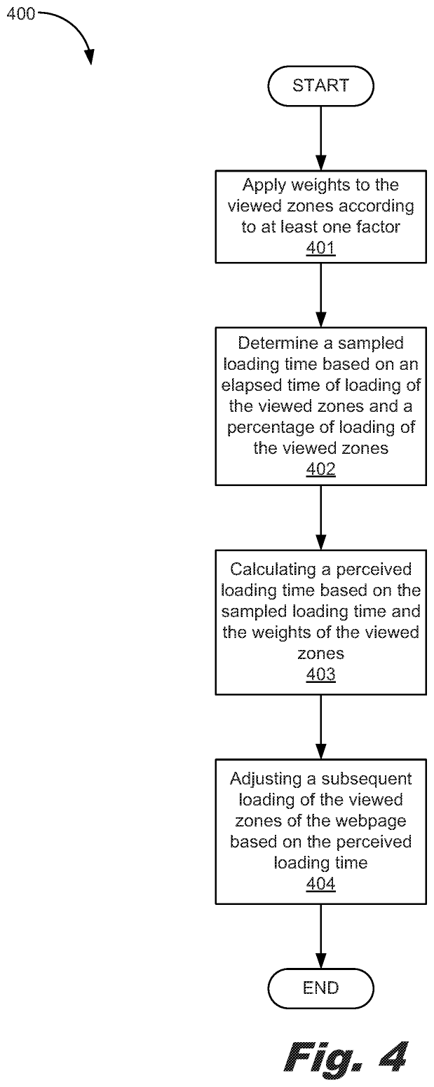

FIG. 4 is a flowchart showing a method (400) of loading objects in web pages, according to an example of the principles described herein. The method (400) may include applying (block 401) weights to the viewed zones (301, 302, 303, 304, 305) according to at least one factor. The weights may be assigned (block 401) by the user, or may be autonomously assigned. In examples where the weights are autonomously assigned, the perceived loading time calculation module (115) may assign (block 401) the weights as based on statistics calculated from a number from end users' access to the web page (300). Certain viewed zones (301, 302, 303, 304, 305) may be given higher or lower weights based on past users' interaction with those viewed zones (301, 302, 303, 304, 305).

The method (400) of FIG. 4 may also include determining (block 402) a sampled loading time based on an elapsed time of loading of the viewed zones (301, 302, 303, 304, 305) and a percentage of loading of the viewed zones (301, 302, 303, 304, 305). The perceived loading time may be calculated (block 403) based on the sampled loading time and the weights of the viewed zones (301, 302, 303, 304, 305). The method (400) may also include adjusting (block 404) a subsequent loading of the viewed zones (301, 302, 303, 304, 305) of the web page (300) based on the perceived loading time. In this manner, the user may have a better experience with the loading of the web page (300), and the web page (300) becomes more effective of a tool to the owner of the web page in presenting the information the owner seeks to present.

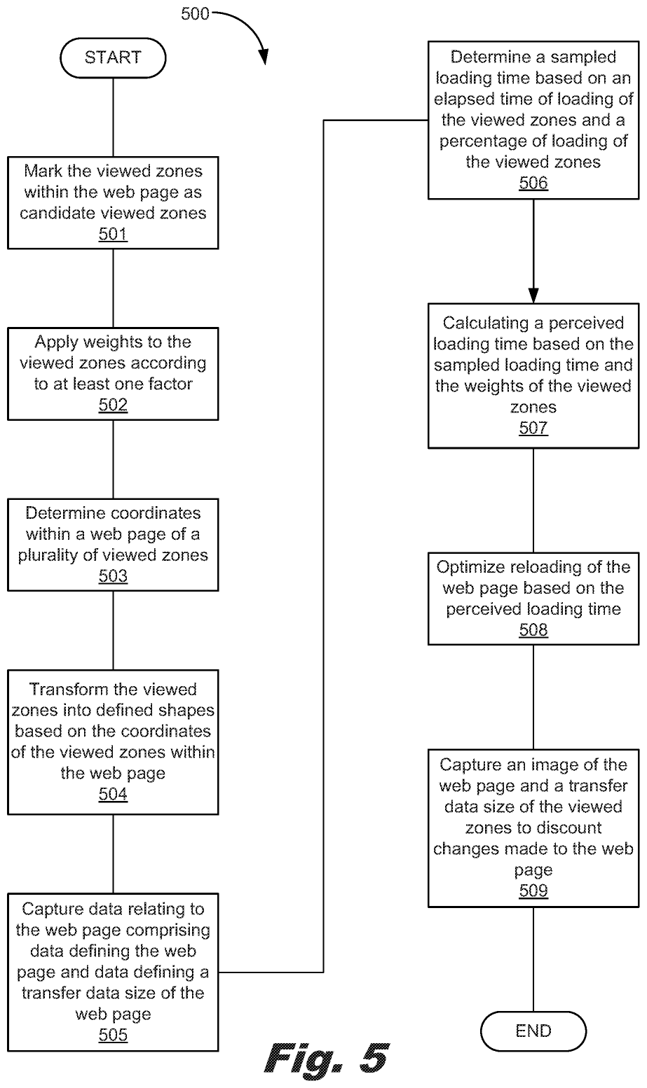

FIG. 5 is a flowchart showing a method (500) of loading objects in web pages (300), according to an example of the principles described herein. The method (500) may begin by marking (block 501) the viewed zones (301, 302, 303, 304, 305) with in the web page (300) as candidate viewed zones (301, 302, 303, 304, 305). The marking (block 501) may be performed by a user who wishes to select portions of a web page (300) for prioritized loading. In another example, the system (100) may mark (block 501) the viewed zones (301, 302, 303, 304, 305) with in the web page (300) as candidate viewed zones (301, 302, 303, 304, 305) based on past users' interactions with portions of the web page (300).

The method (500) may include applying (block 502) weights to the viewed zones (301, 302, 303, 304, 305) according to at least one factor. As described herein, the weights may be assigned (block 502) by the user, or may be autonomously assigned by the system (100). Coordinates within the web page (300) of a plurality of the viewed zones (301, 302, 303, 304, 305) may be determined (block 503). Some portions of web pages (300) may include irregular shapes (350) as described herein. The irregular shapes (350) within viewed zone 1 (301) and viewed zone 2 (302), for example, may be mapped to rectangle or square shapes as depicted in FIG. 3. This simplifies the processing of the viewed zones (301, 302, 303, 304, 305). Thus, determining (block 503) the coordinates within the web page (300) of a plurality of the viewed zones (301, 302, 303, 304, 305) assists in transforming (block 504) the viewed zones (301, 302, 303, 304, 305) into defined shapes based on the coordinates of the viewed zones (301, 302, 303, 304, 305) within the web page (300). The shape of viewed zones (301, 302, 303, 304, 305) may be chosen by programming or based on statistical data such as, for example, recognition of hot viewed zones (301, 302, 303, 304, 305) collected from end users' interaction with the viewed zones (301, 302, 303, 304, 305) among other statistical data.

The method (500) may also include capturing (block 505) data relating to the web page (300). The data captured (block 505) may include data defining the web page (300), data defining a transfer data size of the web page (300), or combinations thereof. A sample loading time may be determined (block 506) based on an elapsed time of loading of the viewed zones (301, 302, 303, 304, 305), a percentage of loading of the viewed zones (301, 302, 303, 304, 305), or combinations thereof.

The perceived loading time of the web page (300) may be calculated (block 507) based on the sampled loading time, the weights of the viewed zones (301, 302, 303, 304, 305), and combinations thereof. Once the perceived loading time has been determined, a reloading of the web page (300) may be optimized (block 508) based on the calculated perceived loading time.

In some examples, an image of the web page (300) and a transfer data size of the viewed zones (301, 302, 303, 304, 305) may be captured (block 509) to discount any changes made to the web page (300). As described herein, web pages (300) are often updated with new and additional information, and being able to maintain values assigned to the viewed zones (301, 302, 303, 304, 305) through different iterations of the web page (300) assist in retaining the analysis performed on the web pages previously.

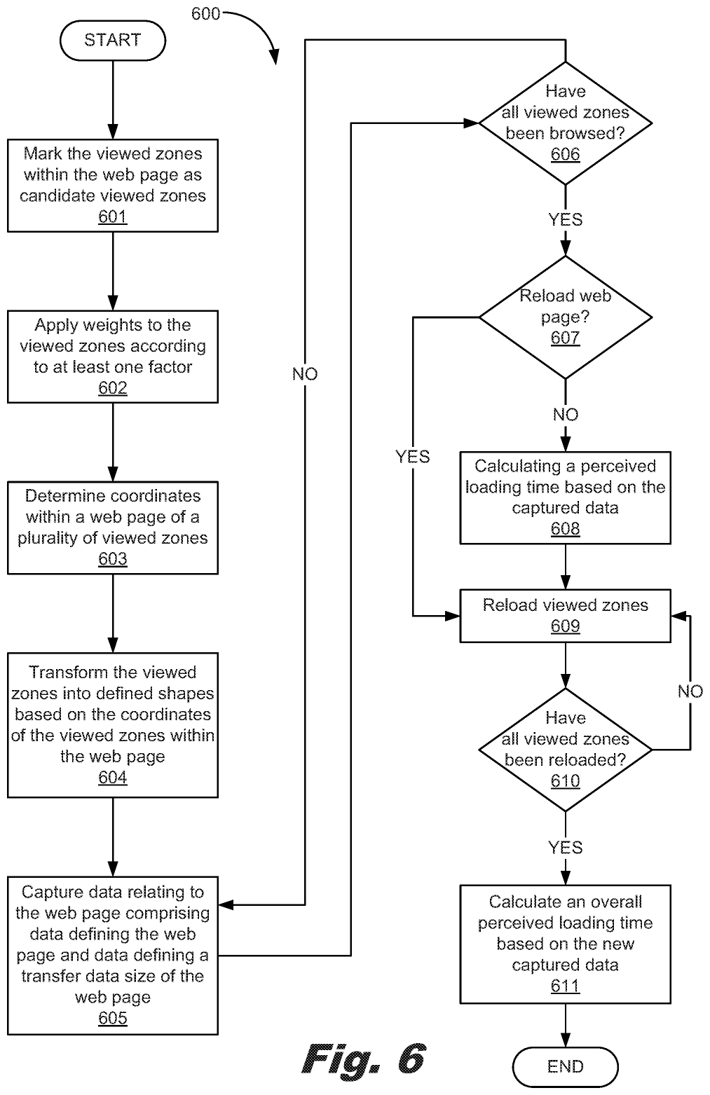

FIG. 6 is a flowchart showing a method (600) of loading objects in web pages, according to an example of the principles described herein. The method (600) may begin by marking (block 601) the viewed zones (301, 302, 303, 304, 305) with in the web page (300) as candidate viewed zones (301, 302, 303, 304, 305). The marking (block 601) may be performed by a user who wishes to select portions of a web page (300) for prioritized loading. In another example, the system (100) may mark (block 601) the viewed zones (301, 302, 303, 304, 305) with in the web page (300) as candidate viewed zones (301, 302, 303, 304, 305) based on past users' interactions with portions of the web page (300).

The method (600) may include applying (block 602) weights to the viewed zones (301, 302, 303, 304, 305) according to at least one factor. As described herein, the weights may be assigned (block 602) by the user, or may be autonomously assigned by the system (100). The weight assigned to the viewed zones (301, 302, 303, 304, 305) indicates the importance of the viewed zones (301, 302, 303, 304, 305).

Coordinates within the web page (300) of a plurality of the viewed zones (301, 302, 303, 304, 305) may be determined (block 603). Some portions of web pages (300) may include irregular shapes (350) as described herein. The irregular shapes (350) within viewed zone 1 (301) and viewed zone 2 (302), for example, may be mapped to rectangle or square shapes as depicted in FIG. 3. This simplifies the processing of the viewed zones (301, 302, 303, 304, 305). Thus, determining (block 603) the coordinates within the web page (300) of a plurality of the viewed zones (301, 302, 303, 304, 305) assists in transforming (block 604) the viewed zones (301, 302, 303, 304, 305) into defined shapes based on the coordinates of the viewed zones (301, 302, 303, 304, 305) within the web page (300). The shape of viewed zones (301, 302, 303, 304, 305) may be chosen by programming or based on statistical data such as, for example, recognition of hot viewed zones (301, 302, 303, 304, 305) collected from end users' interaction with the viewed zones (301, 302, 303, 304, 305) among other statistical data.

The marked viewed zones (301, 302, 303, 304, 305) may be transformed as points within the web page (300) using x, y coordinates. In one example, by using graphics approximation methods, irregular shapes such as the irregular shapes (350) may be approximated into regular shapes which can be easily calculated. At this point, the definition of the viewed zones (301, 302, 303, 304, 305) may be represented as:

viewed zone: [{viewed zone1, weight1}, {viewed zone2, weight2},

...]

(viewed zone array)
for each viewed zone: [Point1, Point2, Point3...]
(point array)
for each point: Point: [x, y coordinates]

The method (600) may also include capturing (block 605) data relating to the web page (300). The data captured (block 605) may include data defining the web page (300), data defining a transfer data size of the web page (300), or combinations thereof. In one example, the data captured at block 605 may be a recording such as an image of the viewed zones (301, 302, 303, 304, 305) that may reflect subtle changes of any of the viewed zones (301, 302, 303, 304, 305) of the web page (300) during the measurement duration. As mentioned herein, changes in a web page (300) may take place often as the web page (300) is updated with additional or new information. The method (600 may account for these changes by updating the data captured at block 605 on a regular basis. Further, the data captured at block 605 may also include a transferred data size represented in bytes or kilobytes for each web page (300) viewed zone (301, 302, 303, 304, 305). The recorded images of the web page (300) and the transferred data size may both be captured, or, in another example, one of these data points may be captured depending on the technical implementation. In examples where the viewed zones (301, 302, 303, 304, 305) change often including in every instance where the viewed zones (301, 302, 303, 304, 305) are loaded, the system (200) may choose to capture (block 605) the transferred data size.

The data captured (block 605) may include the loading time of the viewed zones (301, 302, 303, 304, 305) and the loading degree of the viewed zones (301, 302, 303, 304, 305). The loading time of the viewed zones (301, 302, 303, 304, 305) may be expressed in, for example, seconds (s) such as 0.5s as the loading time of viewed zone 1 (301), 1s as the loading time of viewed zone 2 (302), and 1.6s as the loading time of viewed zone 3 (303). The loading degree of the viewed zones (301, 302, 303, 304, 305) may be expressed in percentages such as, for example, 10% as the loading percentage of viewed zone 1 (301), 20% as the loading percentage of viewed zone 2 (302), and 30% as the loading percentage of viewed zone 3 (303). These captured data may be expressed as follows:

viewed zone 1: [{0.1s, 50%}, {0.2s, 60%}, {0.3s, 70%}, {1.1s, 80%}, {1.2s, 90%}, {1.4s, 100%}];

viewed zone 2: [{0.1s, 40%}, {0.2s, 60%}, {0.3s, 80%}, {1.3s, 100%}]; etc.

In one example, the sampling interval may be defined by a user or a software engineer.

The method (600) may also include determining (block 606) whether all the viewed zones (301, 302, 303, 304, 305) have been browsed. Determining (block 606) whether all the viewed zones (301, 302, 303, 304, 305) have been browsed may include determining if each of the viewed zones (301, 302, 303, 304, 305) have been browsed incrementally and noting that each of the viewed zones (301, 302, 303, 304, 305) have been browsed as the method (600) continues. In response to a determination that not all the viewed zones (301, 302, 303, 304, 305) have not been browsed, (block 606, determination NO), then the method (600) may loop back to block 605 where the data may be captured (block 605) for a number of viewed zones (301, 302, 303, 304, 305) that have not been browsed.

In response to a determination that all the viewed zones (301, 302, 303, 304, 305) have been browsed, (block 606, determination YES), the method (600) may include determining (block 607) whether a reloading of the web page (300) should take place. The reloading module (116) may make this determination (block 607). In response to the determination that the web page (300) is not to be reloaded (block 607, determination NO), then the method (600) may include calculating (block 608) the perceived loading time of the web page (300) based on the captured data.

In response to the determination that the web page (300) is to be reloaded (block 607, determination YES), then the reloading module (116) may, may reload (block 609) the viewed zones (301, 302, 303, 304, 305), and a determination (block 610) as to whether all the viewed zones (301, 302, 303, 304, 305) have been reloaded may be made. If not all the viewed zones (301, 302, 303, 304, 305) have been reloaded (block 610, determination NO), the method may loop back to block 609 for additional viewed zones (301, 302, 303, 304, 305) to be reloaded.

If all the viewed zones (301, 302, 303, 304, 305) have been reloaded (block 610, determination YES), the method may include calculating (block 611) an overall perceived loading time of the web page (300) based on the new captured data obtained from the reloaded viewed zones (301, 302, 303, 304, 305). The calculated perceived loading time may be used by the system to determine if a user's expectation of loading times of the web page (300) and its viewed zones (301, 302, 303, 304, 305) are being met.

The final perceived loading time may be based on multiple viewed zones' (301, 302, 303, 304, 305) perceived time and their weight using a rational formula. The perceive loading time of each viewed zone (301, 302, 303, 304, 305) may be determined by the accepted loading degree. For example, some users may think viewed zone 1 (301) is acceptable or that they are satisfied with the loading of viewed cone 1 (301) after 80% of its loading. In this example, the perceived loading time of viewed zone 1 (301) may be, for example, 1.1s. However, another user may think 100% loading is acceptable benchmark where they may be satisfied with the loading of viewed cone 1 (301). In this example, the perceived loading time of viewed zone 1 (301) may be, for example, 1.4s. Thus, the perceived loading time may be subjective. Because there is no uniform standard for the perceived loading time of each viewed zone (301, 302, 303, 304, 305), the overall perceive loading time may change.

However, a user or a software engineer may define a reasonable time standard based on past user experience or statistical results for applications. For example, if viewed zone 1 (301) includes three images and each of the images are loaded separately, the system (100) may calculate a weighted average value for this viewed zone 1 (301).

By way of example of the methods described herein, the perceived loading time calculation module (115) may define a number of viewed zones (301, 302, 303, 304, 305) and may represent the viewed zones (301, 302, 303, 304, 305) as <list of points, weight>. The list of points may be any collection pf points that may mostly shape the user designated area on the web page such as rectangular shapes and irregular shapes. Irregular shapes may be translated into the viewed zones (301, 302, 303, 304, 305) by dividing the whole web page (300) into reasonable smaller units and identifying a list of points that falls into these units that can shape approximately the user designated area.

A snapshot image of the viewed zones (301, 302, 303, 304, 305) being loaded may be created, and the loading percentage of the viewed zones (301, 302, 303, 304, 305) may be calculated based on effective image quality indexing. The perceived quality of viewed zones (301, 302, 303, 304, 305) being loaded may be calculated based on the overall quality. A total page perceived quality may be found using the following:

(weight1*image_quality(image1))+(weight2*image_quality(image2))+ . . . +(weightn*image_quality(imagen)) Eq. 1

Then, it may be determined whether the page loading quality is good such as, for example, at a perceived quality greater than 90%.

In a second example, the web page (300) may include 3 viewed zones (301, 302, 303, 304, 305). For viewed zones 1, 2, and 3 the sampling interval may be 50 millisecond (ms), 100 ms, and 200 ms, respectively. In this example, the web page with three viewing zones was selected, and the of viewed zones (301, 302, 303, 304, 305), which are represented as a combination of: <shape, weight>, may be set by the user manually or may be loaded from other sources. In one example, a selected viewed zone (301, 302, 303, 304, 305) such as viewed zone 1 (301) may be broken into more view zones if computationally expedient since viewed zone 1 (301) may be loaded gradually.

Taking viewed zone 1 (301) as an example, a data set may be sampled and recording that sampling in the format: <timestamp, zone id, images, size>. This sampled data may be stored in the data storage device (102) as follows:

11:09:10 000, 1 (zone id), screenshot_001. 20Byte(transferred size of the zone)

11:09:10 050, 1 (zone id), screenshot_002, 50Byte(transferred size of the zone)

11:09:10 100, 1 (zone id), screenshot_003, 60Byte(transferred size of the zone)

until the loading of the web page (300) is complete.

The sampling is a good approach for ease of overhead on the browser side process, since different types of viewed zones ((301, 302, 303, 304, 305) may include different sampling intervals. For example, for viewed zones (301, 302, 303, 304, 305) with higher weight, a higher sampling rate or interval may be assigned, and may include a sampling record format of: <timestamp, zone id, images, size>. The images may be screen-shots or screen records, and the size may be transferred content byte size within the viewed zone (301, 302, 303, 304, 305).

Metrics for each viewed zone (301, 302, 303, 304, 305) may be calculated by running, for example, arid effective image quality indexing process, and the resulting record may include a format of:
<zone id, perceived time, load percentage>
view zone 1: 350 ms, 88%; 400 ms, 95%
view zone 2: 300 ms, 86%; 400 ms, 90%
view zone 3: 200 ms, 85%; 400 ms, 88%

For each viewed zone (301, 302, 303, 304, 305), the calculated result may be represented in the format of: <zone id, perceived time, load percentage>. The load percentage may be based on an image quality assessment. One way to assess the quality of an image may include look at the subjective quality measurement mean opinion score (MOS) because human eyes are ultimate receiver. The MOS, although having been used for many years, may be too inconvenient, slow, and expensive. A great deal of effort has been made to develop new objective image and video quality measurement approaches which incorporate perceptual quality measures by considering human visual system characteristics. For example, IBM's Watson Research Center has proposed a new philosophy in designing image quality metrics. The main function of the human eyes is to extract structural information from the viewing field, and the human visual system is highly adapted for this purpose. Therefore, a measurement of structural distortion may be a good approximation of perceived image distortion. In this example, one image may be selected from multiple sample images for evaluation as to a real end user's experience, and the image may be digitized as the load percentage may be calculated with similarity between the satisfied viewed zone (301, 302, 303, 304, 305) screen-shot arid the final loaded viewed zone (301, 302, 303, 304, 305) screen-shot. 100% of the viewed zone (301, 302, 303, 304, 305) loading may be good, but the “satisfied loading time” of the viewed zone (301, 302, 303, 304, 305) may be considered (i.e., the perceived load time). Based on practical experience, in some cases, 90%˜95% load percentage may be satisfactory to the end user. Once the load percentage is calculated, the perceived load time may be determined according to processes of sampling, captured timestamps and screen changing.

The perceived load time and quality calculation and report may be represented as follows:
view zone 1, perceived quality=50%×95%=47.5%
view zone 2, perceived quality=30%×90%=27%
view zone 3, perceived quality=20%×96%=17.6%

So, for the end user:

Total Page Perceived Quality=47.5%+27%+17.6%=92.1%

Perceived Load Time=MAX(load time of view zone 1,2,3)=400 ms

The records may be represented as: <client id, zone id, perceived time, load percentage>, and will be sent to server (150) for further insight. Supposing a load percentage obtained above includes user-satisfied image quality, the following formulas may be expressive of this finding:

Total page perceived quality=weight1*image_quality(image1)+weight2*image_quality(image2)+ . . . +weightn*image_quality(imagen)

Total perceive time=MAX(perceived time of view zones)

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the processor (101) of the computing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures provide for measuring user perceived metrics in performance measurement technologies. The methods and systems described herein assist in analyzing end-to-end performance of any system. Just likepage load time, the perceived loading time is a metric of how quickly a web page is loaded, but also measures the time it takes to actually have the web page ready for the user to use and interact with. While load time measures the actual time it takes to download images, cascading style sheets (CSS), Java script, and other objects in to the user's browser, the perceived loading time is a measure of the time it takes to actually process these objects and display their end-result to the visitor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of loading objects in web pages, comprising:
applying weights to the viewed zones according to at least one factor;
determining a sampled loading time based on an elapsed time of loading of the viewed zones and a percentage of loading of the viewed zones;
calculating a perceived loading time based on the sampled loading time and the weights of the viewed zones; and
adjusting a subsequent loading of the viewed zones of the web page based on the perceived loading time.

2. The method of claim 1, wherein the weighting factors comprise view times statistics viewed zone

3. The method of claim 1, comprising:
determining coordinates within a web page of a plurality of viewed zones;
transforming the viewed zones into defined shapes based on the coordinates of the viewed zones within the web page.

4. The method of claim 1, comprising capturing data relating to the web page comprising data defining the web page and data defining a transfer data size of the web page.

5. The method of claim 1, comprising marking the viewed zones within the web page as candidate viewed zones.

6. The method of claim 1, comprising optimizing reloading of the web page based on the perceived loading time.

7. The method of claim 1, wherein the percentage of loading comprises a percentage of displayed viewed zones of all viewed zones, a percentage of transferred data size of the viewed zone of a total data size of the viewed zone, or combinations thereof.

8. The method of claim 1, further comprising capturing an image of the web page and a transfer data size of the viewed zones to discount changes made to the web page.

9. A computer program product for measuring a perceived web page loading time, the computer program product comprising:
a computer readable storage medium comprising computer usable program code embodied therewith, the computer usable program code to, when executed by a processor:
apply weights to viewed zones of a web page according to at least one factor;
determine a sampled loading time based on an elapsed time of loading of the viewed zones and a percentage of loading of the viewed zones; and
calculate a perceived loading time of the web page based on the sampled loading time the weights of the viewed zones.

10. The computer program product of claim 9, comprising computer usable program code to, when executed by the processor:
determine coordinates of the viewed zones within the web page; and
transform the viewed zones into defined shapes.

11. The computer program product of claim 9, comprising computer usable program code to, when executed by the processor, capture data relating to the web page comprising data defining the web page and data defining a transfer data size of the web page.

12. The computer program product of claim 9, comprising computer usable program code to, when executed by the processor, mark the viewed zones within the web page as candidate viewed zones.

13. The computer program product of claim 9, comprising computer usable program code to, when executed by the processor, optimize reloading of the web page based on the perceived loading time.

14. The computer program product of claim 9, comprising computer usable program code to, when executed by the processor, adjust a subsequent loading of the viewed zones of the web page based on the perceived loading time.

15. The computer program product of claim 9, wherein the percentage of loading comprises a percentage of displayed viewed zones of all viewed zones, a percentage of transferred data size of the viewed zone of a total data size of the viewed zone, or combinations thereof.

16. The computer program product of claim 9, further comprising computer usable program code to, when executed by the processor, capture an image of the web page and a transfer data size of the viewed zones to discount changes made to the web page.

17. A system for measuring a perceived web page loading time, comprising:
a computing device communicatively coupled to a server device through a network, the computing device comprising:
a processor:
a memory device communicatively coupled to the processor, the memory device comprising computer usable program code to, when executed by a processor:
apply weights to viewed zones of a web page according to at least one factor;
determine a sampled loading time based on an elapsed time of loading of the viewed zones and a percentage of loading of the viewed zones; and
calculate a perceived loading time of the web page based on the sampled loading time the weights of the viewed zones.

18. The system of claim 17, comprising computer usable program code to, when executed by the processor:
mark the viewed zones within the web page as candidate viewed zones;
determine coordinates of the viewed zones within the web page; and
transform the viewed zones into defined shapes.

19. The system of claim 17, comprising computer usable program code to, when executed by the processor, capture data relating to the web page comprising data defining the web page and data defining a transfer data size of the web page.

20. The system of claim 17, comprising computer usable program code to, when executed by the processor, adjust a subsequent loading of the viewed zones of the web page based on the perceived loading time.
